(19) United States
(12) Patent Application Publication
(10) Pub. No.: US 2020/0294193 A1
(43) Pub. Date: Sep. 17, 2020

(54) Resizer Method And Apparatus Thereof

(71) Applicant: MediaTek Inc., Hsinchu City (TW)

(72) Inventors: Jing-Ying Chang, Hsinchu City (TW); Ying-Yu Tseng, Hsinchu City (TW); Chi-Cheng Ju, Hsinchu City (TW); Ying-Jui Chen, Hsinchu City (TW); Tung-Hai Wu, Hsinchu City (TW)

(21) Appl. No.: 16/809,806

(22) Filed: Mar. 5, 2020

Related U.S. Application Data
(60) Provisional application No. 62/818,787, filed on Mar. 15, 2019.

(51) Int. Cl. G06T 3/40; G06T 1/20; G06F 9/38

(52) U.S. Cl. CPC G06T 3/4015; G06F 9/3867; G06T 1/20

(57) ABSTRACT

Various examples pertaining to utilization of a resizer in image processing are described. A processor of an apparatus receives image data of a captured image from an image sensor. The processor processes the image data through a pipeline in which the image data is resized before further processing is performed to provide processed data of a processed image used in preview or video recording.

### CROSS REFERENCE TO RELATED PATENT APPLICATION(S)

The present disclosure is part of a non-provisional application claiming the priority benefit of U.S. Provisional Patent Application No. 62/818,787, filed 15 Mar. 2019, the content of which being incorporated by reference in its entirety.

### TECHNICAL FIELD

The present disclosure is generally related to image processing and, more particularly, to utilization of a resizer in image processing.

### BACKGROUND

Unless otherwise indicated herein, approaches described in this section are not prior art to the claims listed below and are not admitted as prior art by inclusion in this section.

As the pixel count of image sensors continues to increase, the performance of image signal processor (ISP) modules need to be boosted to provide zero-shutter delay image-capture capability with real-time preview or video recording. Although more powerful processing units could be utilized as a straightforward solution, such approach would result in a sizable increase in cost. Another approach to providing high throughout would be to down-scale the previous and video image in the ISP to effectively reduce overall throughput, but user experience would be negatively impacted.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, solutions, concepts, designs, methods and apparatuses for image processing with a frontal resizer that resizes, or down-scales, image data of a received image before further processing, including demosaicing, is performed on the image data. It is believed that proposed schemes in accordance with the present disclosure may avoid high cost and reduction in overall throughput associated with existing approaches.

In one aspect, a method may involve receiving image data of a captured image from an image sensor. The method may also involve processing the image data through a pipeline in which the image data is resized before further processing is performed to provide processed data of a processed image used in preview or video recording.

In another aspect, a method may involve receiving image data of a captured image from an image sensor. The method may also involve resizing the image data by a resizer to provide resized data. The method may further involve demosaicing the resized data by a demosaicing module (DM) before further processing to provide processed data of a processed image used in preview or video recording.

In yet another aspect, an apparatus may include at least one image sensor configured to capture an image to provide image data. The apparatus may also include a processor coupled to receive the image data from the image sensor. The processor may include an image signal processing (ISP) pipeline through which the image data is processed to provide processed data of a processed image used in preview or video recording such that the image data is resized before further processing is performed in the ISP pipeline to provide the processed data.

It is noteworthy that, although description provided herein may be in the context of certain topologies such as a resizer in an ISP, the proposed concepts, schemes and any variation(s)/derivative(s) thereof may be implemented in, for and by other image processing technologies that are to be developed in the future as well as any other image processing technology not mentioned herein whether implicitly or explicitly. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example apparatus in accordance with an implementation of the present disclosure.

FIG. 2 is a diagram of an example apparatus in accordance with an implementation of the present disclosure.

FIG. 3 is a diagram of an example apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

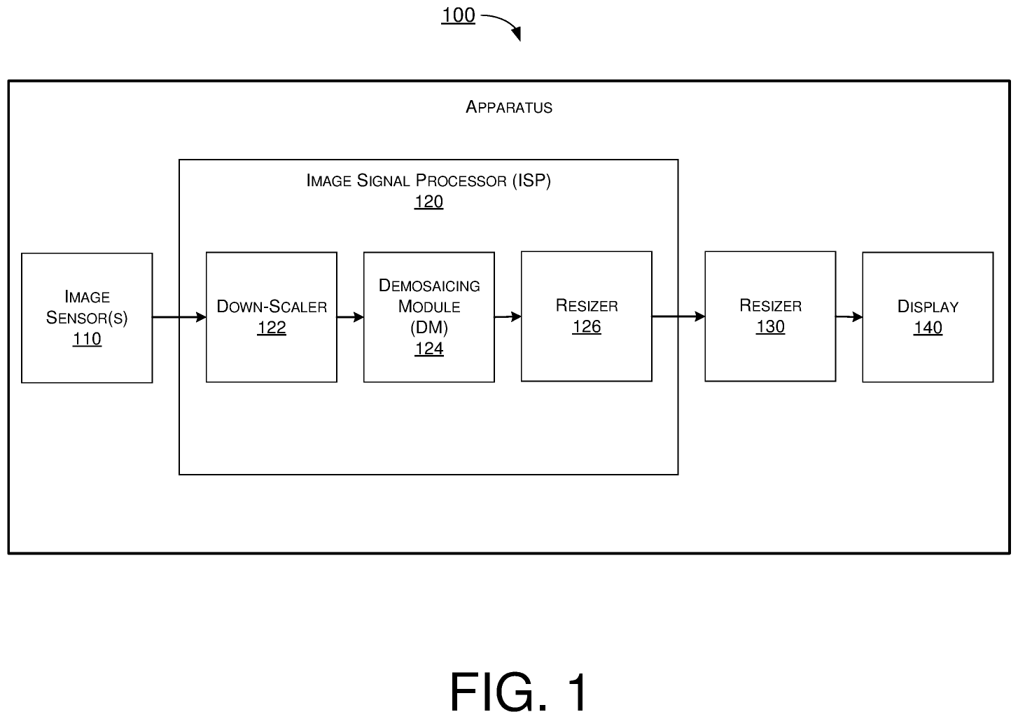

FIG. 1 illustrates an example apparatus 100 in accordance with an implementation of the present disclosure. Referring to FIG. 1, apparatus 100 may include one or more image sensors 110, an image signal processor (ISP) 120, a resizer 130 and a display 140. Each of the one or more image sensors 110 may respectively capture images of a given scene and/or object. ISP 120 may receive image data of the captured images from image sensor(s) 110 to perform certain image processing on the image data to provide processed data to resizer 130. Resizer 130 may resize the processed data before recording or display. That is, resizer 130 may resize the processed data to provide resized processed data to display 140 which may be utilized to provide preview and/or video recording for viewing by a user. The sensor pixel count of each image sensor of image sensor(s) 110 may be denoted as Pₛ. Depending on the actual implementation, the pixel count of display 140 may be different and may be denoted as P_{d} which may be arbitrary depending on actual implementations. For instance, the pixel count of display 140 may be 8 megapixels (or P_{d}=8M) in case display 140 is implemented with a 4K2K display. Alternatively, the pixel count of display 140 may be 2 megapixels (or P_{d}=2M) in case display 140 is implemented with a full high-definition (FHD) display. In any event, the pixel count of image sensor(s) 110 is much greater than that of display 140 (e.g., Pₛ>>P_{d}).

Under a proposed scheme in accordance with the present disclosure, ISP 120 may be configured, designed or otherwise built with an image processing pipeline which down-scales the image data before further processing is performed to provide processed data of a processed image. Under the proposed scheme, in processing the image data through the pipeline, ISP 120 may process the image data through the pipeline in which down-scaling by down-scaler 122 is performed before demosaicing by DM 124 to provide the processed data. For instance, in processing the image data through the pipeline, ISP 120 may process the image data sequentially through down-scaler 122, followed by DM 124, and then resizer 126. In some cases, down-scaler 122 may down-scale the image data to provide down-scaled data with a down-scaled pixel count lower than a sensor pixel count of the image data from image sensor(s) 110. Under the proposed scheme, a sensor pixel count of image sensor(s) 110 may be higher than a down-scaled pixel count of the image data after the down-scaling which may be higher than a pixel count of the processed data. In such cases, the pixel count of the processed data may be 8 megapixels in case display 140 includes a 4K2K display or 2 megapixels in case display 140 includes a FHD display.

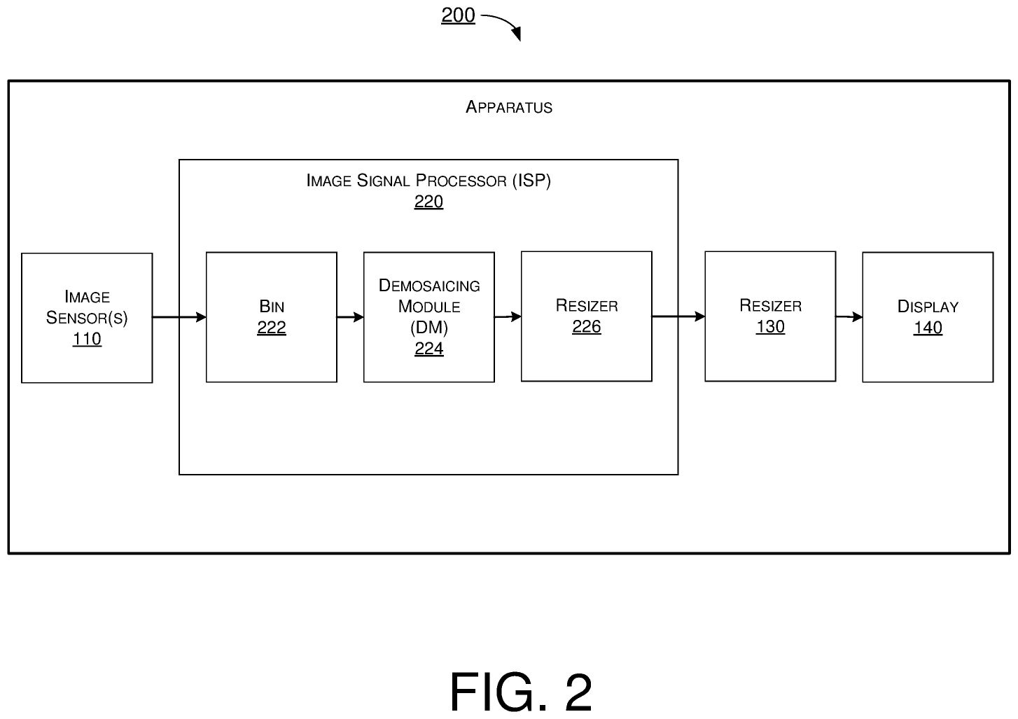

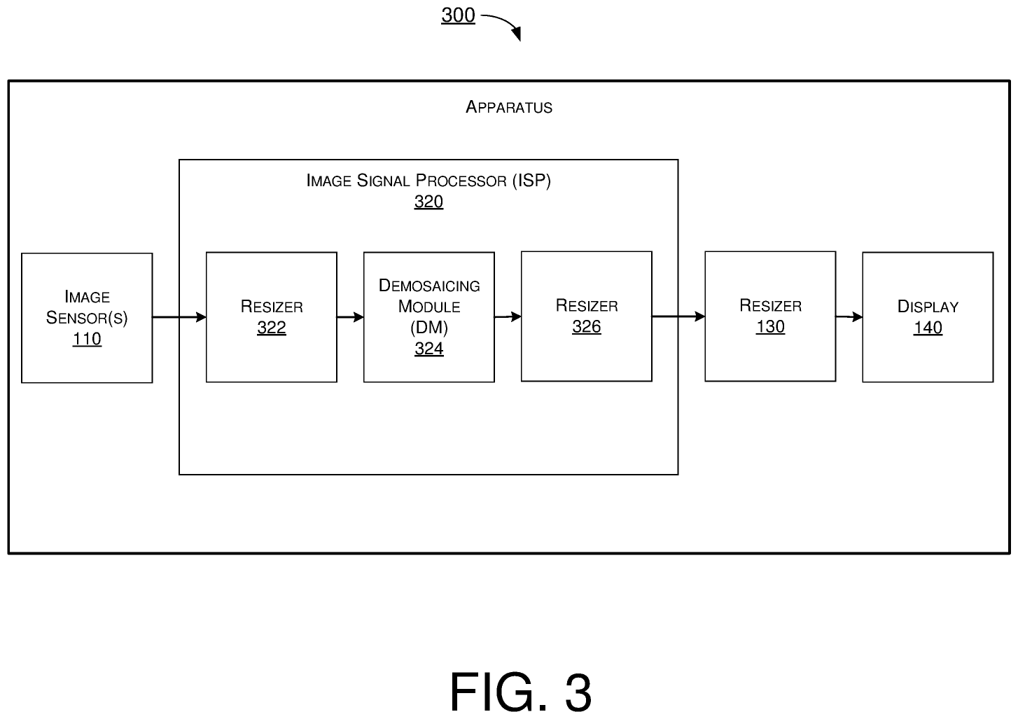

Under the proposed scheme, down-scaler 122 may be implemented with either a bin (shown in FIG. 2) or a resizer (shown in FIG. 3). In case down-scaler 122 is implemented with a bin, the bin may be a fixed-size binning module that has a fixed down-scaling ratio of 1/2 in that the bin may down-scale the image data by 50%. In case down-scaler 122 is implemented with a resizer, the resizer may have an arbitrary or otherwise adjustable down-scaling ratio which may be varied or adjusted depending on one or more factors such as, for example and without limitation, a pixel count of image sensor(s) 110, a field of view (FOV) of the preview on display 140, a capacity of ISP 120 in processing the image data, and a power capacity concern of the system (e.g., apparatus 100).

FIG. 2 illustrates an example apparatus 200 in accordance with an implementation of the present disclosure. Referring to FIG. 2, apparatus 200 may include one or more image sensors 110, an ISP 220, a resizer 130 and a display 140. Apparatus 200 differs from apparatus 100 in that ISP 220 includes a fixed-size binning module 222 (shown as “bin 222” in FIG. 2) in place of down-scaler 122 in ISP 120. Other components of apparatus 200 may be identical or otherwise similar to the counterparts of apparatus 100 and thus, in the interest of brevity, detailed description of apparatus 200 is not provided to avoid redundancy.

Under a proposed scheme in accordance with the present disclosure, ISP 220 may be configured, designed or otherwise built with an image processing pipeline which down-scales the image data before further processing is performed to provide processed data of a processed image. Under the proposed scheme, in processing the image data through the pipeline, ISP 220 may process the image data through the pipeline in which down-scaling by fixed-size binning module 222 is performed before demosaicing by DM 124 to provide the processed data. For instance, in processing the image data through the pipeline, ISP 220 may process the image data sequentially through fixed-size binning module 222, followed by DM 124, and then resizer 126. In some cases, fixed-size binning module 222 may reduce the size of image data by a fixed amount (e.g., 50% or 75%) to provide down-scaled data with a fixed-sized pixel count lower than a sensor pixel count of the image data from image sensor(s) 110. Thus, a sensor pixel count of image sensor(s) 110 may be higher than a fixed-sized pixel count of the image data after the down-sizing which may be higher than a pixel count of the processed data. The pixel count of the down-sized data may be denoted as P_{b}, with P_{b}=Pₛ/2 or Pₛ/4 and P_{b}>>P_{d} in case the fixed down-scaling ratio of fixed-size binning module 222 is 1/2 or 1/4, respectively.

However, as fixed-size binning module 222 down-scales the image data by a fixed ratio, the resultant processed data may not be visually pleasant to an end user. Accordingly, the use of fixed-size binning module 222 may be suitable for designs and applications for non-vision use supports such as artificial intelligence (Al) and computer vision (CV).

FIG. 3 illustrates an example apparatus 300 in accordance with an implementation of the present disclosure. Referring to FIG. 3, apparatus 300 may include one or more image sensors 110, an ISP 320, a resizer 130 and a display 140. Apparatus 300 differs from apparatus 100 in that ISP 320 includes a resizer 322 in place of down-scaler 122 in ISP 120. Other components of apparatus 300 may be identical or otherwise similar to the counterparts of apparatus 100 and thus, in the interest of brevity, detailed description of apparatus 300 is not provided to avoid redundancy.

Under a proposed scheme in accordance with the present disclosure, ISP 320 may be configured, designed or otherwise built with an image processing pipeline which resizes the image data before further processing is performed to provide processed data of a processed image. Under the proposed scheme, in processing the image data through the pipeline, ISP 320 may process the image data through the pipeline in which resizing by resizer 322 is performed before demosaicing by DM 124 to provide the processed data. For instance, in processing the image data through the pipeline, ISP 320 may process the image data sequentially through resizer 322, followed by DM 124, and then resizer 126. In some cases, resizer 322 may resize the image data to provide resized data with a resized pixel count lower than a sensor pixel count of the image data from image sensor(s) 110. Under the proposed scheme, a sensor pixel count of image sensor(s) 110 may be higher than a resized pixel count of the image data after the resizing which may be higher than a pixel count of the processed data.

As resizer 322 may down-scale the image data by an arbitrary or adjustable ratio, the resultant quality may be better. The pixel count of the resized data may be denoted as Pᵣ, with Pₛ>>Pᵣ>>P_{d}. With resizer 322 placed before DM 124 in the image processing pipeline, a resultant image with sufficient quality for preview and/or video recording may be produced. Advantageously, this design may save computation resources in the pipeline before DM 124. Moreover, with the design shown in FIG. 3, resizer 322 may receive and resize image data of any size to down-scale the pixel count of the image data to Pᵣ which is enough for DM 124. In contrast, with a fixed down-scaling ratio, the quality of the resultant image by using fixed-size binning module 222 may be worse.

### Illustrative Processes

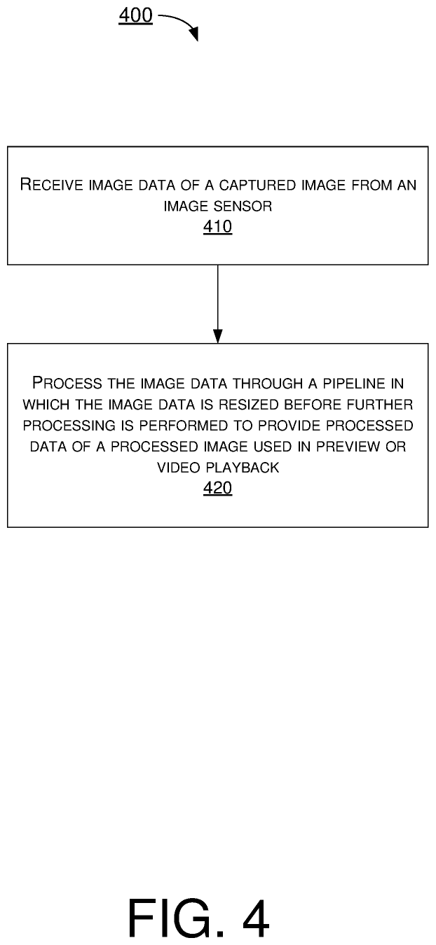

FIG. 4 illustrates an example process 400 in accordance with an implementation of the present disclosure. Process 400 may be an example implementation of the various procedures, scenarios, schemes, solutions, concepts and techniques, or a combination thereof, whether partially or completely, with respect to utilization of a frontal resizer in image processing in accordance with the present disclosure. Process 400 may represent an aspect of implementation of features of apparatus 300. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Furthermore, one or more of the blocks of process 400 may be repeated one or more times. Process 400 may be implemented by apparatus 100, apparatus 200, apparatus 300 or any variation thereof. Solely for illustrative purposes and without limitation, process 400 is described below in the context of apparatus 300. Process 400 may begin at block 410.

At 410, process 400 may involve ISP 320 of apparatus 300 receiving image data of a captured image from image sensor(s) 110. Process 400 may proceed from 410 to 420.

At 420, process 400 may involve ISP 320 processing the image data through a pipeline in which the image data is resized (e.g., by resizer 322) before further processing is performed by other components of ISP 320 to provide processed data of a processed image used in preview or video recording on display 140.

In some implementations, in processing the image data through the pipeline, process 400 may involve ISP 320 processing the image data through the pipeline in which resizing by resizer 322 is performed before demosaicing by DM 324 to provide the processed data.

In some implementations, in processing the image data through the pipeline, process 400 may involve ISP 320 processing the image data sequentially through resizer 322 as a first resizer, DM 324, and then resizer 326 as a second resizer. In such cases, resizer 322 may resize the image data to provide resized data with a resized pixel count lower than a sensor pixel count of the image data from image sensor(s) 110.

In some implementations, a sensor pixel count of image sensor(s) 110 may be higher than a resized pixel count of the image data after the resizing which may be higher than a pixel count of the processed data. In such cases, the pixel count of the processed data may be the same as display size such as, for example and without limitation, 8 megapixels (8M) in a 4K2K display, 2 megapixels (2M) in a FHD display, or a different size depending on actual implementations.

In some implementations, image sensor(s) 110 may include a plurality of image sensors. In such cases, in receiving the image data from image sensor(s) 110, process 400 may involve ISP 320 receiving respective image data of a respective captured image from one of the plurality of image sensors each having a respective pixel count. Moreover, in processing the image data through the pipeline, process 400 may involve resizer 322 resizing the respective image data by a respective ratio corresponding to the respective pixel count of the one of the plurality of image sensors.

In some implementations, in processing the image data through the pipeline in which the image data is resized, process 400 may involve resizer 322 resizing the image data by a ratio which is variable based on one or more of: (a) a pixel count of image sensor(s) 110; (b) a field of view (FOV) of the preview; (c) a capacity of ISP 320 in processing the image data; and (d) a power capacity concern of the system (e.g., apparatus 300).

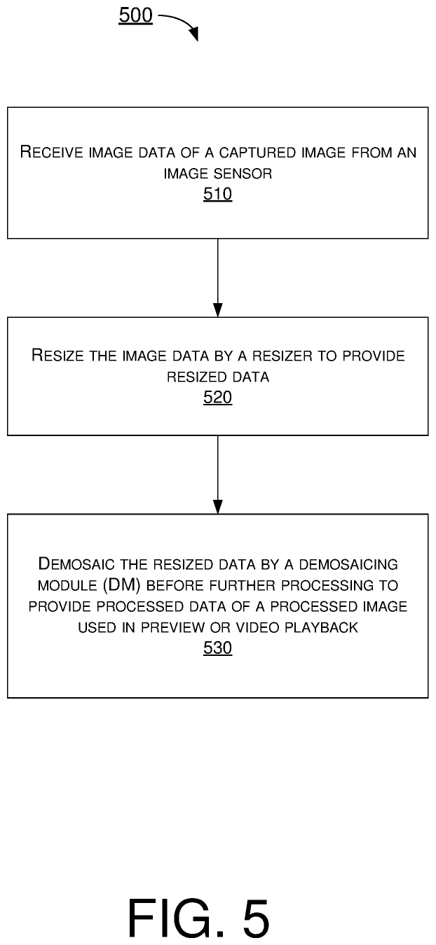

FIG. 5 illustrates an example process 500 in accordance with an implementation of the present disclosure. Process 500 may be an example implementation of the various procedures, scenarios, schemes, solutions, concepts and techniques, or a combination thereof, whether partially or completely, with respect to utilization of a frontal resizer in image processing in accordance with the present disclosure. Process 500 may represent an aspect of implementation of features of apparatus 300. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Furthermore, one or more of the blocks of process 500 may be repeated one or more times. Process 500 may be implemented by apparatus 100, apparatus 200, apparatus 300 or any variation thereof. Solely for illustrative purposes and without limitation, process 500 is described below in the context of apparatus 300. Process 500 may begin at block 510.

At 510, process 500 may involve ISP 320 receiving image data of a captured image from image sensor(s) 110. Process 500 may proceed from 510 to 520.

At 520, process 500 may involve resizer 322 resizing the image data to provide resized data. Process 500 may proceed from 520 to 530.

At 530, process 500 may involve DM 324 demosaicing the resized data before further processing by other components of ISP 320 to provide processed data of a processed image used in preview or video recording on display 140.

In some implementations, in resizing the image data, process 500 may involve resizer 322 providing the resized data with a resized pixel count lower than a sensor pixel count of the image data from image sensor(s) 110.

In some implementations, a sensor pixel count of image sensor(s) 110 may be higher than a resized pixel count of the resized data which may be higher than a pixel count of the processed data. In such cases, the pixel count of the processed image may be the same as display size such as, for example and without limitation, 8M in a 4K2K display, 2M in a FHD display, or a different size depending on actual implementations.

In some implementations, image sensor(s) 110 may include a plurality of image sensors. In such cases, in receiving the image data from image sensor(s) 110, process 500 may involve ISP 320 receiving respective image data of a respective captured image from one of the plurality of image sensors each having a respective pixel count. Moreover, in processing the image data through the pipeline, process 500 may involve resizer 322 resizing the respective image data by a respective ratio corresponding to the respective pixel count of the one of the plurality of image sensors.

In some implementations, in resizing the image data, process 500 may involve resizer 322 resizing the image data by a ratio which is variable based on one or more of: (a) a pixel count of image sensor(s) 110; (b) a field of view (FOV) of the preview; (c) a capacity of ISP 320 in processing the image data; and (d) a power capacity concern of the system (e.g., apparatus 300).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving image data of a captured image from an image sensor; and
processing the image data through a pipeline in which the image data is resized before further processing is performed to provide processed data of a processed image used in preview or video recording.

2. The method of claim 1, wherein the processing of the image data through the pipeline comprises processing the image data through the pipeline in which resizing by a resizer is performed before demosaicing by a demosaicing module (DM) to provide the processed data.

3. The method of claim 1, wherein the processing of the image data through the pipeline comprises processing the image data sequentially through a first resizer, a demosaicing module (DM), and a second resizer, and wherein the first resizer resizes the image data to provide resized data with a resized pixel count lower than a sensor pixel count of the image data from the image sensor.

4. The method of claim 1, wherein a sensor pixel count of the image sensor is higher than a resized pixel count of the image data after the resizing which is higher than a pixel count of the processed data.

5. The method of claim 1, wherein the receiving of the image data from the image sensor comprises receiving respective image data of a respective captured image from one of a plurality of image sensors each having a respective pixel count, and wherein the processing of the image data through the pipeline comprises resizing the respective image data by a respective ratio corresponding to the respective pixel count of the one of the plurality of image sensors.

6. The method of claim 1, wherein the processing of the image data through the pipeline in which the image data is resized comprises resizing the image data using a resizer by a ratio which is variable based on one or more of:
a pixel count of the image sensor;
a field of view (FOV) of the preview;
a capacity of an image signal processor (ISP) in processing the image data; and
a system power capacity concern.

7. A method, comprising:
receiving image data of a captured image from an image sensor;
resizing the image data by a resizer to provide resized data; and
demosaicing the resized data by a demosaicing module (DM) before further processing to provide processed data of a processed image used in preview or video recording.

8. The method of claim 7, wherein the resizing of the image data comprises providing the resized data with a resized pixel count lower than a sensor pixel count of the image data from the image sensor.

9. The method of claim 7, wherein a sensor pixel count of the image sensor is higher than a resized pixel count of the resized data which is higher than a pixel count of the processed data.

10. The method of claim 7, wherein the receiving of the image data from the image sensor comprises receiving respective image data of a respective captured image from one of a plurality of image sensors each having a respective pixel count, and wherein the resizing of the image data comprises resizing the respective image data by a respective ratio corresponding to the respective pixel count of the one of the plurality of image sensors.

11. The method of claim 7, wherein the resizing of the image data comprises resizing the image data by a ratio which is variable based on one or more of:
a pixel count of the image sensor;
a field of view (FOV) of the preview;
a capacity of an image signal processor (ISP) in processing the image data; and
a system power capacity concern.

12. An apparatus, comprising:
at least one image sensor configured to capture an image to provide image data; and
a processor coupled to receive the image data from the image sensor, the processor comprising an image signal processing (ISP) pipeline through which the image data is processed to provide processed data of a processed image used in preview or video recording such that the image data is resized before further processing is performed in the ISP pipeline to provide the processed data.

13. The apparatus of claim 12, wherein, in processing the image data through the ISP pipeline, the processor is configured to process the image data through the ISP pipeline in which resizing by a resizer is performed before demosaicing by a demosaicing module (DM) to provide the processed data.

14. The apparatus of claim 12, wherein the ISP pipeline comprises a resizer and a demosaicing module (DM), wherein the resizer resizes the image data to provide resized data with a resized pixel count lower than a sensor pixel count of the image data from the image sensor, and wherein the DM performs demosaicing on the resized data.

15. The apparatus of claim 12, wherein a sensor pixel count of the image sensor is higher than a resized pixel count of the resized data which is higher than a pixel count of the processed data.

16. The apparatus of claim 12, wherein the at least one image sensor comprises a plurality of image sensors each having a respective pixel count and configured to capture a respective image to provide respective image data, and wherein a resizer of the processor is configured to resize the respective image data from one of the plurality of image sensors by a respective ratio corresponding to the respective pixel count of the one of the plurality of image sensors.

17. The apparatus of claim 12, wherein a resizer of the processor is configured to resize the image data by a ratio which is variable based on one or more of:
a pixel count of the image sensor;
a field of view (FOV) of the preview;
a capacity of an image signal processor (ISP) in processing the image data; and
a power capacity concern of the apparatus.
